(19) United States
(12) Patent Application Publication
(10) Pub. No.: US 2025/0111424 A1
(43) Pub. Date: Apr. 3, 2025

(54) PLACEMENT OF CONTENT IN A STOREFRONT USER INTERFACE PAGE BY AN ONLINE SYSTEM

(71) Applicant: Maplebear Inc., San Francisco, CA (US)

(72) Inventors: Nan Ma, San Francisco, CA (US); Xinglu Wang, Fremont, CA (US); Chao Zhang, Sunnyvale, CA (US); Bo Han, Brampton (CA)

(21) Appl. No.: 18/374,448

(22) Filed: Sep. 28, 2023

(51) Int. Cl. G06Q 30/0601; G06Q 30/0201

(52) U.S. Cl. CPC G06Q 30/0639; G06Q 30/0201; G06Q 30/0635; G06Q 30/0641

(57) ABSTRACT

An online system hosts a retailer storefront user interface for a third-party retailer that includes content associated with items offered by the retailer for procurement and delivery through the online system. A retailer may provide preferences for where different candidate content is placed in the retailer storefront user interface. The online system applies a machine learning model to the retailer preferences and other contextual information relating to a particular presentation of the retailer storefront user interface to dynamically rank content for different possible placement positions. The ranking scores may relate to predicted performance metrics associated with operations of the online system. Content is then placed in the retailer storefront user interface based on the respective ranking scores.

### BACKGROUND

An online system may host one or more retailer-specific pages that present content specific to the retailer and enables viewing and purchasing of items available from that retailer. Processing of the orders may then be facilitated through a backend infrastructure of the online system. Conventionally, individual retailers are afforded controls that may enable an administrator to manually select placement of content on the retailer's personalized storefront. For example, a retailer may select to place content associated with certain items available from the retailer more prominently due to promotional incentives available to the retailer. However, such decisions can fail to optimize placement according to various performance metrics based on data available to the online system, but not necessarily exposed to the retailer.

### SUMMARY

To address the above-described problems, an online system enables automated placement of content on a retailer storefront user interface in a manner that considers both retailer preferences and various optimizations enabled through historical data accessible to the online system. In one or more embodiments, the online system receives, from a user client device, a request for generation of a retailer storefront user interface associated with a retailer affiliated with the online system. The online system obtains retailer-specified preferences (which may be preconfigured) associated with placements of candidate content in available placement positions in the retailer storefront user interface, and obtains contextual data associated with presentation of the retailer storefront user interface. In one or more embodiments, the contextual data may include a profile of a user associated with the user client device, a time of day, a season, and promotional data associated with items available from the retailer. The online system applies a machine learning model to the retailer-specified preferences and the contextual data to generate respective ranking scores associated with each of the candidate content for the available placement positions. The machine learning model may be trained on historical data of the online system to optimize a performance metric associated with its operation. For example, the performance metric may be derived from at least one of a click-through-rate (CTR), a gross transaction value (GTV), and a gross merchandise value (GMV) associated with the retailer storefront user interface. The online system determines, based on the respective ranking scores, respective placements of the candidate content in the retailer storefront user interface. In some instances, the respective placements determined based on the respective ranking scores may vary from than the retailer-specified preferences. The online system then outputs the retailer storefront user interface to the user client device.

In one or more embodiments, the online system may subsequently receive, via the retailer storefront user interface, a selection of one or more items for adding to an order of a user associated with the user client device. The online system may then facilitate processing of the order to procure the one or more items and deliver the one or more items to the user.

In one or more embodiments, the candidate content may include a combination of retailer-curated content specified by the retailer and system-curated content generated automatically without input from the retailer. The candidate content may include one or more digital banners that include respective links to respective landing pages that enable adding items available from the retailer to an order for a user associated with the user client device. Furthermore, the candidate content may include one or more product carousels that include a set of item elements for different items available from the retailer and respective controls for adding one or more selected items to an order for a user associated with the user client device. The product carousels are associated with corresponding product categories that have different selection and ranking rules for selecting and ranking the items.

In further embodiments, a non-transitory computer-readable storage medium stores instructions executable by a processor for carrying out any of the processes described herein. Furthermore, a computer system may include a process and a non-transitory computer-readable storage medium as described herein.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3A is a first example embodiment of a retailer storefront user interface hosted by an online system.

FIG. 3B is a second example embodiment of a retailer storefront user interface hosted by an online system.

FIG. 4 is an embodiment of a retailer storefront generation module of an online system.

FIG. 5 is an embodiment of a process for generating a retailer storefront user interface hosted by an online system.

### DETAILED DESCRIPTION

An online system, such as an online concierge system, dynamically generates and hosts a retailer storefront user interface for a third-party retailer. The retailer storefront user interface includes content associated with items offered by the retailer that may be procured and delivered though the online system. A retailer may provide preferences for where different candidate content is placed in the retailer storefront user interface. The online system applies a machine learning model to the retailer preferences and other contextual information relating to a particular presentation of the retailer storefront user interface to dynamically rank content for different possible placement positions. The ranking scores may relate to predicted performance metrics associated with operations of the online system. Content is then placed in the retailer storefront user interface based on the respective ranking scores.

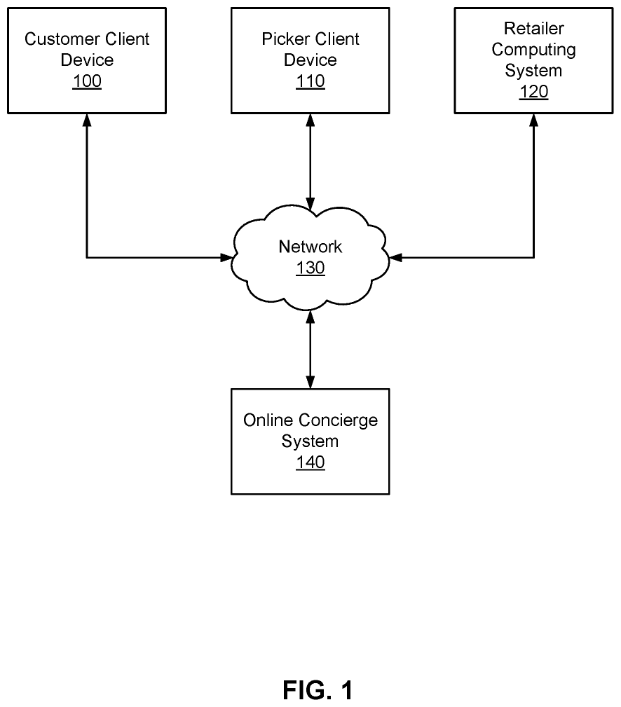

In one or more embodiments, the online system is an online concierge system. FIG. 1 illustrates an example system environment of an online concierge system 140, in accordance with one or more embodiments. The system environment illustrated in FIG. 1 includes a user client device 100, a picker client device 110, a retailer computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, users, pickers, and retailers may be generically referred to as “users” of the online concierge system 140. Additionally, while one user client device 100, picker client device 110, and retailer computing system 120 are illustrated in FIG. 1, any number of users, pickers, and retailers may interact with the online concierge system 140. As such, there may be more than one user client device 100, picker client device 110, or retailer computing system 120.

The user client device 100 is a client device through which a user may interact with the picker client device 110, the retailer computing system 120, or the online concierge system 140. The user client device 100 can be a personal or mobile computing device, such as a smartphone, a tablet, a laptop computer, or desktop computer. In some embodiments, the user client device 100 executes a client application that uses an application programming interface (API) to communicate with the online concierge system 140.

A user uses the user client device 100 to place an order with the online concierge system 140. An order specifies a set of items to be delivered to the user. An “item”, as used herein, means a good or product that can be provided to the user through the online concierge system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The user client device 100 presents an ordering interface to the user. The ordering interface is a user interface that the user can use to place an order with the online concierge system 140. The ordering interface may be part of a client application operating on the user client device 100. The ordering interface allows the user to search for items that are available through the online concierge system 140 and the user can select which items to add to a “shopping list.” A “shopping list,” as used herein, is a tentative set of items that the user has selected for an order but that has not yet been finalized for an order. The ordering interface allows a user to update the shopping list, e.g., by changing the quantity of items, adding or removing items, or adding instructions for items that specify how the item should be collected.

The user client device 100 may receive additional content from the online concierge system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online concierge system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same retailer location. The collection interface further presents instructions that the user may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the user client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a user's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the user client device 100 for display to the user such that the user can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a user from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The user client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which users can order items to be provided to them by a picker from a retailer. The online concierge system 140 receives orders from a user client device 100 through the network 130. The online concierge system 140 selects a picker to service the user's order and transmits the order to a picker client device 110 associated with the picker. The picker collects the ordered items from a retailer location and delivers the ordered items to the user. The online concierge system 140 may charge a user for the order and provides portions of the payment from the user to the picker and the retailer.

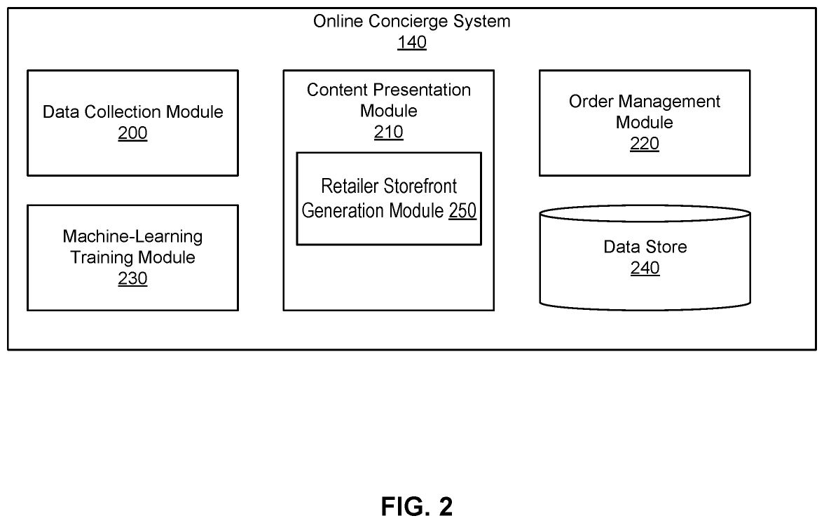

As an example, the online concierge system 140 may allow a user to order groceries from a grocery store retailer. The user's order may specify which groceries they want delivered from the grocery store and the quantities of each of the groceries. The user client device 100 transmits the user's order to the online concierge system 140 and the online concierge system 140 selects a picker to travel to the grocery store retailer location to collect the groceries ordered by the user. Once the picker has collected the groceries ordered by the user, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, or stored payment instruments. The user data also may include default settings established by the user, such as a default retailer/retailer location, payment instrument, delivery location, or delivery timeframe. The data collection module 200 may collect the user data from sensors on the user client device 100 or based on the user's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the user client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has services orders for the online concierge system 140, a user rating for the picker, which retailers the picker has collected items at, or the picker's previous shopping history. Additionally, the picker data may include preferences expressed by the picker, such as their preferred retailers to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a user associated with the order, a retailer location from which the user wants the ordered items collected, or a timeframe within which the user wants the order delivered. Order data may further include information describing how the order was serviced, such as which picker serviced the order, when the order was delivered, or a rating that the user gave to the delivery of the order.

The content presentation module 210 selects content for presentation to a user. For example, the content presentation module 210 selects which items to present to a user while the user is placing an order. The content presentation module 210 generates and transmits the ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine learning models and may be stored in the data store 240. For example, the content presentation module 210 may present one or more recommended repurchase items that the user has purchased before and is likely to repurchase. These items may be identified and displayed without the user necessarily entering any explicit search query.

In some embodiments, the content presentation module 210 scores items based on a search query received from the user client device 100. A search query is text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a user based on whether the predicted availability of the item exceeds a threshold.

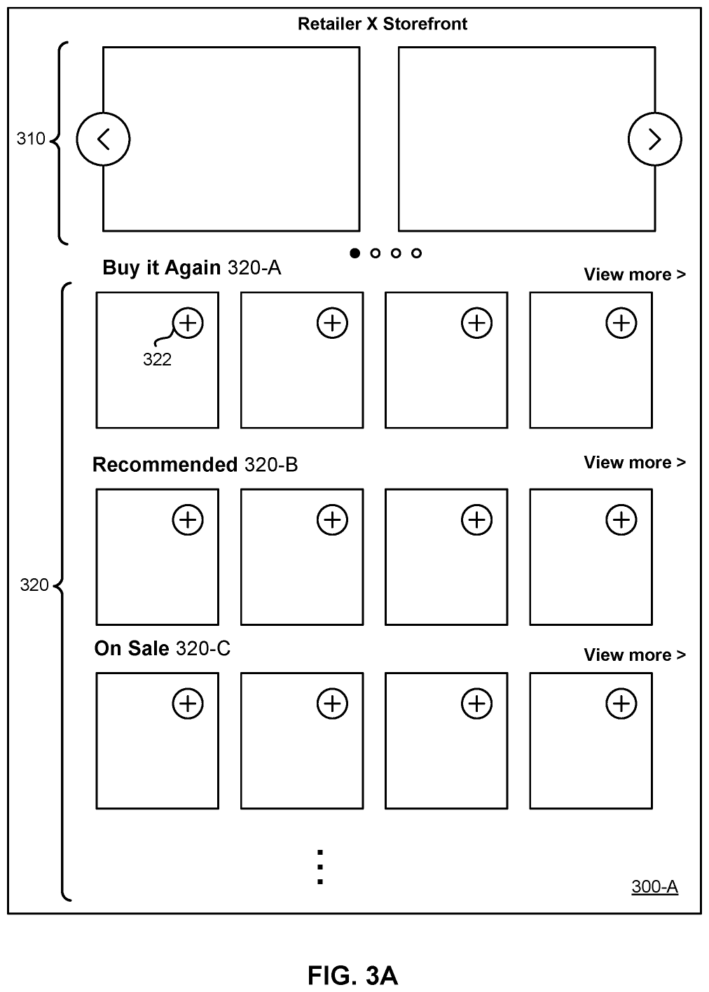

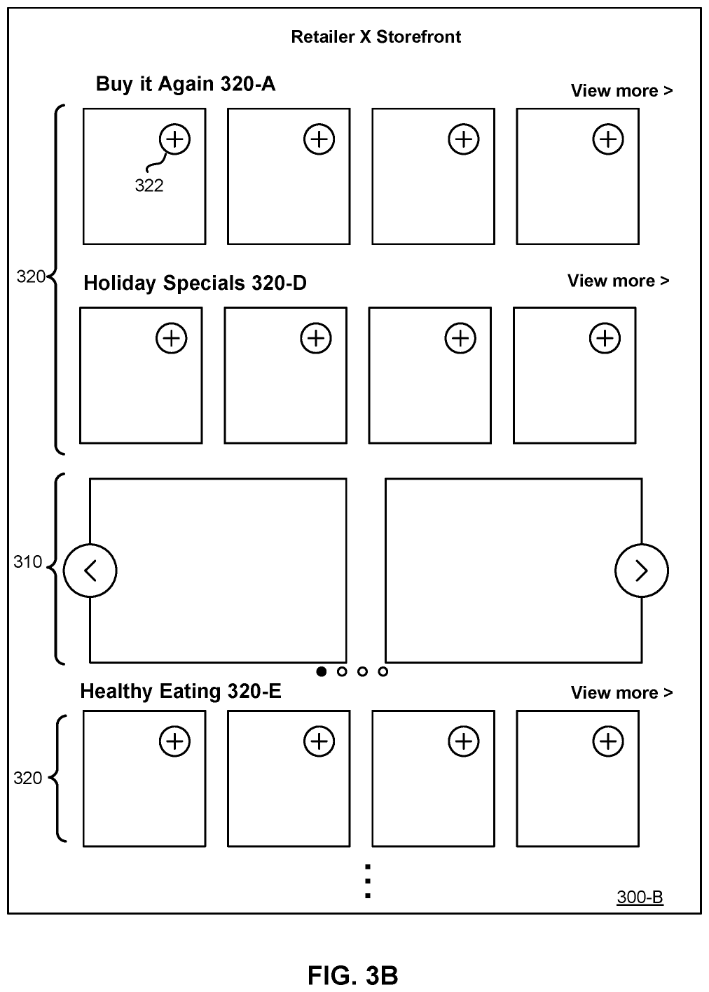

The content presentation module 210 may include a retailer storefront generation module 212 that generates one or more retailer storefront interfaces associated with a specific retailer. A retailer storefront may enable searching, browsing, and viewing of items available for purchase from that retailer, enable creation of orders for items from that retailer, and enable purchasing, procurement and delivery of items from the retailer in the same manner described above. A retailer storefront may be accessible through a web page or mobile application associated with the online concierge system 140 (e.g., by selecting a specific retailer from a list of available retailers), or may be accessible through a web page or mobile application associated with the retailer. In the latter situation, the retailer may utilize the online concierge system 140 as a “white label” service, where the backend functions of the online concierge system 140 are employed, but the user-facing aspects are presented consistently with the retailer-specific branding, product offerings, pricing, etc. The retailer storefront generation module 212 is described in further detail below in association with FIGS. 3-5.

The order management module 220 manages orders for items from users. The order management module 220 receives orders from a user client device 100 and assigns the orders to pickers for service based on picker data. For example, the order management module 220 assigns an order to a picker based on the picker's location and the location of the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to assign an order to a picker based on a delivery timeframe requested by the user with the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the user with the location of the picker so that the user can track the progress of their order. In some embodiments, the order management module 220 computes an estimated time of arrival for the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes a total cost for the order and charges the user that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include user data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores user data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

FIGS. 3A-3B illustrate examples of retailer storefront user interfaces 300-A, 300-B (collectively referenced herein as retailer storefront user interface 300) that may be generated by the retailer storefront generation module 250. A retailer storefront user interface 300 may present content in various forms and may include retailer-curated content, system-curated content, or a combination thereof. Retailer-curated content may comprise content specified by the retailer. The system-curated content may comprise various types of content generated by the online concierge system 140 without direct input from the retailer. System-curated content may be dynamically generated in a manner that is tailored to retailer-specific item inventories, retailer pricing, retailer promotions, and other retailer specific information. The system-curated content may furthermore be dynamically tailored to a viewing user and/or other dynamical contextual information. The system-curated content may be automatically generated based on various algorithms executed by the online concierge system 140 using various machine learning algorithms, heuristics-based algorithms, or other system-implemented processes as described herein.

Content on the retailer storefront user interface 300 may include one or more digital banners 310 and one or more product carousels 320. The digital banners 310 may comprise various multimedia (e.g., images, text, animations, and/or video) and a link to an associated landing page. The landing page may include information about a specific item or category of items available from the retailer, and/or may include controls that enable browsing of items, adding items to orders, or other interactions. The digital banners and associated landing pages may relate to item categories such as seasonal products (e.g., Halloween candy), items relevant to the time of day (e.g., coffee products in the morning), or other arbitrarily created item categories or individual items.

A digital banner 310 may be defined based on various characteristics including its display dimensions (e.g., width and height), its title, its description, its multimedia content, its navigation targets (links) or other action triggered by its selection. The content associated with a specific digital banner 310 may be static, or may be dynamically selected based on configured rules. For example, a digital banner 310 may be configured to change content depending on a daily schedule (e.g., displaying a coffee item in the morning and dessert items in the evening), on a seasonal basis (e.g., displaying candy items near Halloween), or based on other factors.

Digital banners 310 may be displayed independently, or may be arranged in a banner carousel comprising a set of rotating banners that are rotatable into different positions. A banner carousel may optionally include more banners 310 than available display slots, such that banners rotate in and out of the display slots. For example, a banner carousel may have ten total slots and three display slots in which three of the ten banners are displayed at any given time. In each rotation, at least one banner is rotated into the display slot and at least one banner is rotated out of the display slot. In one example, a banner carousel may be in the form of a periodically rotating carousel in which the digital banners automatically rotate on a periodic basis (e.g., every few seconds). In another example, a banner carousel may be in the form of a scrollable carousel in which the carousel rotates in response to a user selection of a scroll control (e.g., a scroll left and/or scroll right control).

Digital banners 310 and/or banner carousels that are retailer-curated may be configured by a retailer. For example, the retailer may configure the content, navigation targets, and/or dynamic rules for dynamically configuring the digital banners or banner carousels. In other embodiments, digital banners may be system-curated, and their configuration and content may be determined automatically by the online concierge system 140 without necessarily utilizing direct input from an administrator of the retailer.

A product carousel 320 may comprise a set of content elements that are each directly associated with an item available for purchase from the retailer via the online concierge system 140. Each element of a product carousel 320 may include an “add to cart” control 322 that, when selected, causes the item to be directly added to an order for processing through the online concierge system 140. Each content element of a product carousel 320 may be displayed with a graphic and/or text describing the associated item and may include other information such as a price (or price per unit), inventory, or other information.

Product carousels 320 may each be associated with a category that affects the content elements (and associated items) it includes. Examples of categories for product carousels 320 may include, for example, a “Buy it Again” category that includes items that the viewing user has previously purchased, a “Weekly Savings” category limited to items that are on sale, a “Featured” category limited to items selected for promotion, an “On Sale” category for items that are currently on sale, seasonal categories such as “Thanksgiving Dinner”, or other categories defined by the online concierge system 140.

A product carousel 320 may be defined according to a category identifier that identifies the category and a linked set of selection and ordering rules that control the dynamic selection of items from the retailer for including in each product carousel 320 and the order of items within each product carousel 320. The item selection and ranking rules may comprise a set of static rules for some categories or may be based on application of one or more machine learning models trained to optimize item selection and ranking according to one or more optimization metrics (e.g., predicted click through rate (CTR), gross transaction value (GTV), gross merchandise value (GMV), or other metric). For various categories, the specific item selection and ranking rules may be based on dynamic factors such as the identity or characteristics of the viewing user, purchase history of the viewing user, item inventories for the retailer, or other dynamic factors. Thus, a product carousel category may include different items depending on the retailer, the user, and various contextual information.

In an example embodiment, the product carousels 320 are system-curated. For example, the online concierge system 140 may define various categories for product carousels that may be utilized on different retailer storefront user interfaces 300 for different retailers. In other embodiments, product carousels 320 could be retailer-curated and include selection and ranking rules that are configured by the retailer.

Retailer storefronts user interfaces 300 may additionally include other displayed content that is not necessarily in the form of digital banners 310 or product carousels 320. For example, the retailer storefront user interface 300 may include browsing controls for browsing items, search controls for searching items, standalone product videos, interactive elements, or other content.

The various content (e.g., digital banners 310, product carousels 320, or other content) may be dynamically arranged in the retailer storefront user interface 300 when the retailer storefront user interface 300 is presented. Here, a ranking algorithm generates ranking scores for a set of candidate content, which may include a combination of retailer-curated content (e.g., digital banners or digital banner carousels) and system-curated content (e.g., product carousels associated with different predefined categories). The ranking scores may then be used to select and place candidate content on the retailer storefront user interface 300 at defined placement positions. For example, depending on the results of the ranking process, different banners 310 or product carousels 320 may be placed in or more or less prominent positions in the interface 300. The ranking scores may be generated in a manner that is specific to the viewing user, current inventory, current retailer pricing, time of day, season, current promotions, or other dynamic information. Thus, the resulting placements may be different for different viewing users at different times. The ranking algorithm may operate to generate the ranking scores in a manner that optimizes a performance metric associated with the online concierge system 140 as will be further described below.

In some embodiments, at least some of the content on the retailer storefront user interface 300 may instead comprise pinned content that is not dynamically placed and is instead statically pinned to a specific placement (e.g., at the top of the user interface 300 or another prominent position). The selection and placement of a pinned banner may be selectable by an administrator of the retailer.

FIGS. 3A-3B illustrate examples of possible arrangements of content in a retailer storefront user interface 300. In the illustrated example interface 300-A of FIG. 3A, a set of retailer-curated content include a set of digital banners 310 that link to respective landing pages (which may enable browsing and purchasing of relevant products, or other retailer-specific content). These digital banners 310 may relate to promotional products, seasonal products, or other products or product categories that the retailer wants to promote. Below the digital banners 310, a set of product carousels 320 are displayed (e.g., one row per product carousel 320) relating to different categories. A “Buy it Again” product carousel 320-A is placed below the digital banners 310, followed by a “Recommended” product carousel 320-B, followed by an “On Sale” product carousel 320-C, and so on. In this example, the product carousels 320 are system-curated content generated by the online concierge system 140 according to the predefined categories. In FIG. 3B, the dynamic ranking results in different ranking and placement. In this example, the “Buy it Again” product carousel 320-A ranked highest, followed by a “Holiday Specials” product carousel 320-D, then the digital banners 310 (retailer-curated, in this case), and then a “Healthy Eating” product carousel 320-E.

In the examples of FIGS. 3A-3B, each placement position is defined by a row of the interface 300 and more prominent positions are associated with rows near the top of the interface 300. In other examples, placement positions may comprise columns, specific positions within a row or column, or other areas of rectangular or arbitrary shape. Different placement positions may be associated with different prominence levels in any defined manner.

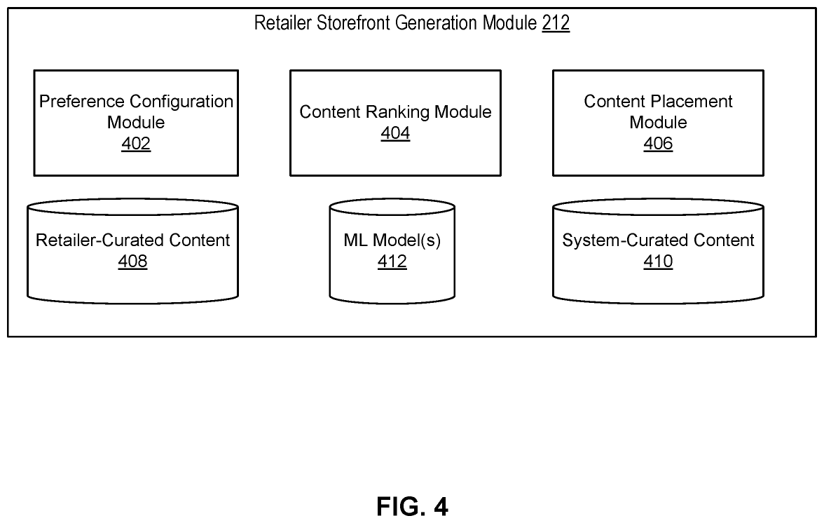

FIG. 4 illustrates an example embodiment of a retailer storefront generation module 212. The retailer storefront generation module 212 comprises a preference configuration module 402, a content ranking module 404, a content placement module 406, a retailer-curated content store 408, and a system-curated content store 410, and one more machine learning models 412. In alternative embodiments, the retailer storefront generation module 212 may comprise different or additional modules.

The preference configuration module 402 comprises an interface for enabling a retailer to input preferences associated with placement of retailer-curated content and/or system-curated content. For example, the preference configuration module 402 may enable a retailer to create, select, or update one or more digital banners 310 or other retailer-curated content that they want to display. The preference configuration module 402 may furthermore provide an interface to enable a retailer to indicate placement preferences associated with retailer-curated content, available system-curated content, or both. The placement preferences may indicate a specific placement preferences (e.g., top of page, 2^{nd} row, 3^{rd} row, etc.) from a set of predefined placement locations for each of the available content. Alternatively, the placement preferences may comprise a preferred ranking score or relative prominence level for different content (without necessarily specifying a specific placement). In other embodiments, the placement preference may comprise a general preference to “boost” certain content to more prominent positions.

The content ranking module 404 dynamically generates ranking scores for candidate content in association with generating a specific presentation of the retailer storefront user interface 300. Here, the content ranking module 404 may jointly rank both retailer-curated content and system-curated content according to a machine learning model 412. The machine learning model 412 may be trained on historical data associated with operation of the online concierge system 140 relating to historical presentations of retailer storefront user interfaces 300 (which may include data across multiple different retailers), contextual data associated with the presentations, and resulting interactions. For example, the historical data may include placement preferences specified by retailers in association with a historically presented retailer storefront user interface 300, the actual placements of different types of content on the retailer storefront user interfaces 300 (e.g., digital banners 310 and product carousels 320 by category), various contextual data, and various performance metrics associated with the presentation. The contextual data may include information such as a time of day, a season, characteristics of a viewing user such as demographic information and purchase history, cost of items associated with presented content, inventory of items associated with content, sale status of items, promotional incentives from a supplier, or other factors. The performance metrics may comprise data such as CTRs or other interaction-based metrics associated with content at a particular placement, or attributions of GTV, GMV, or other value-based metric to each displayed content at the respective placements. For digital banners 310 that link to a landing page (rather than directly adding a product to an order), the attributed value for a digital banner may be estimated based on tracking source pages associated with product purchases and matching the source pages to landing pages associated with digital banners 310. Performance metrics may also be based on various other trackable user interactions with content or various combinations of different metrics. During training, the machine learning algorithm learns relationships between the input data and the resulting performance metrics. The machine learning algorithm may be trained according to regression-based techniques, neural networks, or other machine learning techniques described herein with respect to the machine learning training module 230.

The content ranking module 404 may apply the machine learning model 412 to infer ranking scores associated with different candidate content for an available placement location on a retailer storefront user interface 300. Here, the content ranking module 404 may collectively rank both retailer-curated content and system-curated content for each available placement position. The content ranking module 404 incorporates the retailer preferences as a factor that may affect the inferences made by the machine learning model 412, but these preferences are not directly enforced (i.e., the content is not necessarily pinned to the retailer-preferred placement). Rather, the machine learning model 412 learns how the retailer preferences (in combination with other input factors) differently affects the resulting performance metrics when followed or not followed, such that these preferences can be utilized as inputs to predict which placements will best optimize performance metrics in a given context.

The content placement module 406 determines how to place candidate content based on the respective ranking scores of the candidate content for each of the placement positions. In one example implementation, the content placement module 406 may sequentially select content for each placement position (e.g., starting with the most prominent placement and proceeding to the least prominent position). For each placement, the content placement module 406 determines the highest scoring content of remaining candidate content that has not already been placed elsewhere. In another embodiment, an optimization function may be applied to jointly optimize across all placements based on a joint optimization metric (e.g., cumulative ranking scores). In further embodiments, the content placement module 406 may utilize a different set of rules or heuristics to place candidate content based on the ranking scores. For example, placement rules may restrict placement of certain candidate content to a limited set of possible placements independently of the ranking scores.

The retailer-curated content store 408 and the system-curated content store 410 store the retailer curated content and the system-curated content respectively, as described above. Digital banners 310 may be stored based on their title, description, navigation targets, multimedia content, click through action (CTA), or other information. Product carousels 320 may be stored based on their respective category identifiers that reference selection rules for choosing relevant items in the respective categories.

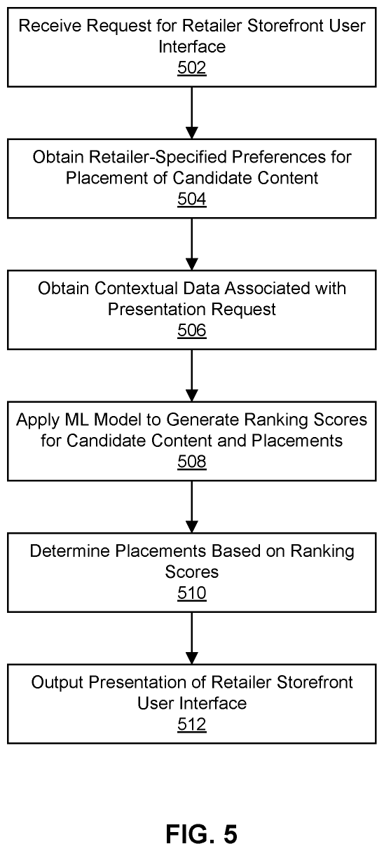

FIG. 5 is a flowchart for a method of generating a retailer storefront user interface 300 for presentation in a user client device 100. Alternative embodiments may include more, fewer, or different steps from those illustrated in FIG. 5, and the steps may be performed in a different order from that illustrated in FIG. 5. At least some of the steps may be performed automatically by the online concierge system 140 without human intervention.

The online concierge system 140 receives 502, from a user client device 100, a request for generating a retailer storefront user interface 300 associated with a retailer. For example, the request may be received when a user client device 100 accesses a web page or application page corresponding to the retailer storefront user interface 300. The online concierge system 140 obtains 504 retailer-specified preferences associated with placements of candidate content to available placement positions. The retailer-specified preferences may be preconfigured by the retailer and stored by the online concierge system 140. The retailer-specified preference may include a preferred ranking of available content items or more general preferences to boost certain candidate content to more prominent positions. The online concierge system 140 also obtains 506 contextual data associated with the presentation request for the retailer storefront user interface 300. For example, the contextual data may include a profile of a user associated with the user client device, a time of day, a season, and promotional data associated with items available from the retailer, or other information that may be utilized to predict performance associated with different possible placement configurations.

The online concierge system then applies 508 a machine learning model to the retailer-specified preferences and the contextual data to generate respective ranking scores associated with each of the candidate content for the available placement positions. As described above, the machine learning model may be trained on historical data of the online concierge system to optimize a performance metric such as a predicted CTR, attributed GTV, attributed GMV, or combination thereof. The machine learning model may jointly rank retailer-curated content (e.g., digital banners 310) and system-curated content (e.g., product carousels 320 associated with one or more predefined categories). The online concierge system 140 determines 510, based on the respective ranking scores, respective placements of the candidate content in the retailer storefront user interface 300. Because the retailer preferences are utilized as inputs to the machine learning model but do not directly control placement, the respective placements may vary in various instances from the placements specified in the retailer-specified preferences.

Once the placements have been determined for the user interface, the online concierge system outputs 512 the retailer storefront user interface 300 to the user client device 100. This causes the user device to display the storefront user interface 300 to the user, who can then interact with the storefront user interface 300. In one or more embodiments, the online concierge system logs these interactions and uses them to retrain the models, as described above. In this way, the system continues to improve in its task of arranging user interface options for users in a way that improves the user interface and thereby the user's ability to access functionalities of the online concierge system.

The process of FIG. 5 may be executed each time the retailer storefront user interface 300 is requested, and the specific placements of content in the resulting interfaces 300 may vary between iterations depending on the viewing user or other contextual information.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, the method comprising:
receiving, at an online system from a user client device, a request for generation of a retailer storefront user interface for a retailer associated with the online system;
obtaining retailer-specified preferences for placements of candidate content in placement positions of the retailer storefront user interface;
obtaining contextual data associated with a presentation of the retailer storefront user interface;
applying a machine learning model to the retailer-specified preferences and the contextual data to generate a ranking score for each of the candidate content for the placement positions, wherein the machine learning model is trained on historical data of the online system to predict a performance metric associated with operation of the online system;
generating, based on the ranking scores, respective placements of the candidate content in the retailer storefront user interface; and
sending the retailer storefront user interface to the user client device, wherein sending the retailer storefront user interface to the user client device causes the user client device to display the retailer storefront user interface.

2. The method of claim 1, further comprising:
obtaining the candidate content by obtaining a combination of retailer-curated content specified by the retailer and system-curated content generated automatically without input from the retailer.

3. The method of claim 1, further comprising:
obtaining the candidate content by obtaining one or more digital banners that include links to respective landing pages that enable adding of items available from the retailer to an order for a user associated with the user client device.

4. The method of claim 1, further comprising:
obtaining the candidate content by obtaining one or more product carousels that include a set of item elements for different items available from the retailer and respective controls for adding one or more selected items to an order for a user associated with the user client device.

5. The method of claim 4, wherein the product carousels are associated with corresponding product categories, and wherein the product carousels have different selection and ranking rules for selecting and ranking the items in the corresponding product categories.

6. The method of claim 1, further comprising:
deriving the performance metric from at least one of a click-through-rate (CTR), a gross transaction value (GTV), or a gross merchandise value (GMV) associated with the retailer storefront user interface.

7. The method of claim 1, further comprising:
receiving, via the retailer storefront user interface, a selection of one or more items for adding to an order of a user associated with the user client device; and
facilitating, by the online system, processing of the order to procure the one or more items and deliver the one or more items to the user.

8. The method of claim 1, wherein in at least one instance, the placements determined based on the ranking scores vary from than the retailer-specified preferences.

9. The method of claim 1, wherein obtaining the contextual data comprises obtaining at least one of a profile of a user associated with the user client device, a time of day, a season, or promotional data associated with items available from the retailer.

10. A non-transitory computer-readable storage medium storing instructions executable by a processor for performing steps comprising:
receiving, at an online system from a user client device, a request for generation of a retailer storefront user interface for a retailer associated with the online system;
obtaining retailer-specified preferences for placements of candidate content in placement positions of the retailer storefront user interface;
obtaining contextual data associated with a presentation of the retailer storefront user interface;
applying a machine learning model to the retailer-specified preferences and the contextual data to generate a ranking score for each of the candidate content for the placement positions, wherein the machine learning model is trained on historical data of the online system to predict a performance metric associated with operation of the online system;
generating, based on the ranking scores, respective placements of the candidate content in the retailer storefront user interface; and
sending the retailer storefront user interface to the user client device, wherein sending the retailer storefront user interface to the user client device causes the user client device to display the retailer storefront user interface.

11. The non-transitory computer-readable storage medium of claim 10, wherein the non-transitory computer-readable storage medium further stores instructions executable by a processor for performing steps comprising:
obtaining the candidate content by obtaining a combination of retailer-curated content specified by the retailer and system-curated content generated automatically without input from the retailer.

12. The non-transitory computer-readable storage medium of claim 10, wherein the non-transitory computer-readable storage medium further stores instructions executable by a processor for performing steps comprising:
obtaining the candidate content by obtaining one or more digital banners that include links to respective landing pages that enable adding of items available from the retailer to an order for a user associated with the user client device.

13. The non-transitory computer-readable storage medium of claim 10, wherein the non-transitory computer-readable storage medium further stores instructions executable by a processor for performing steps comprising:
obtaining the candidate content by obtaining one or more product carousels that include a set of item elements for different items available from the retailer and respective controls for adding one or more selected items to an order for a user associated with the user client device.

14. The non-transitory computer-readable storage medium of claim 13, wherein the product carousels are associated with corresponding product categories, and wherein the product carousels have different selection and ranking rules for selecting and ranking the items in the corresponding product categories.

15. The non-transitory computer-readable storage medium of claim 10, wherein the non-transitory computer-readable storage medium further stores instructions executable by a processor for performing steps comprising:
deriving the performance metric from at least one of a click-through-rate (CTR), a gross transaction value (GTV), or a gross merchandise value (GMV) associated with the retailer storefront user interface.

16. The non-transitory computer-readable storage medium of claim 10, wherein the non-transitory computer-readable storage medium further stores instructions executable by a processor for performing steps comprising:
receiving, via the retailer storefront user interface, a selection of one or more items for adding to an order of a user associated with the user client device; and
facilitating, by the online system, processing of the order to procure the one or more items and deliver the one or more items to the user.

17. The non-transitory computer-readable storage medium of claim 10, wherein in at least one instance, the placements determined based on the ranking scores vary from than the retailer-specified preferences.

18. The non-transitory computer-readable storage medium of claim 10, wherein obtaining the contextual data comprises obtaining at least one of a profile of a user associated with the user client device, a time of day, a season, or promotional data associated with items available from the retailer.

19. A computer system comprising:
a processor; and
a non-transitory computer-readable storage medium storing instructions executable by the processor for performing steps comprising:
receiving, at an online system from a user client device, a request for generation of a retailer storefront user interface for a retailer associated with the online system;
obtaining retailer-specified preferences for placements of candidate content in placement positions of the retailer storefront user interface;
obtaining contextual data associated with a presentation of the retailer storefront user interface;
applying a machine learning model to the retailer-specified preferences and the contextual data to generate a ranking score for each of the candidate content for the placement positions, wherein the machine learning model is trained on historical data of the online system to predict a performance metric associated with operation of the online system;
generating, based on the ranking scores, respective placements of the candidate content in the retailer storefront user interface; and
sending the retailer storefront user interface to the user client device, wherein sending the retailer storefront user interface to the user client device causes the user client device to display the retailer storefront user interface.

20. The computer system of claim 19, wherein obtaining the contextual data comprises obtaining at least one of a profile of a user associated with the user client device, a time of day, a season, or promotional data associated with items available from the retailer.
